(19) United States
(12) Patent Application Publication
(10) Pub. No.: US 2004/0145908 A1
(43) Pub. Date: Jul. 29, 2004

(54) Light source housing and light device with a light source securing mechanism

(75) Inventors: Eric John Ognian, Canton, MI (US); Dean Bryant Bowles, Commerce, MI (US)

Correspondence Address: Thomas E. Wettermann, McDonnell Boehnen Hulbert & Berghoff, 32nd Floor, 300 S. Wacker Drive, Chicago, IL, 60606, US

(73) Assignee: North American Lighting, Inc., Farmington Hills, MI (US)

(21) Appl. No.: 10/352,781

(22) Filed: Jan. 28, 2003

(51) Int. Cl. F21V 7/00

(52) U.S. Cl. 362/516; 362/519; 362/351

(57) ABSTRACT

A light source housing and light device with a light source securing mechanism is provided. The light housing has a reflector with a mounting block on its backside. A bulb shield with a mounting arm is mounted within the housing such that a curved end of the mounting arm slides over the mounting block. A portion of the curved end extends beyond the mounting block providing an area to fasten a light source within the light housing using a retaining spring.

### FIELD OF INVENTION

The present invention relates to light devices, and more particularly, to a light source housing and a light device with a light source securing mechanism.

### BACKGROUND

Automotive light devices today are designed to meet light output requirements and to be aesthetically pleasing for external view. Lighting devices typically include a reflective housing designed to hold a light bulb. The reflective housing is typically hemi-spherically shaped and the light bulb is mounted in the center of the reflector. However, the light bulb can be mounted in various positions within the housing.

As one example, the light bulb may be mounted in the center of the reflector by positioning a base of the bulb through a hole of the reflector from the backside of the reflector. The bulb typically will sit in a slot since the hole will be formed to be a size such that the base of the bulb will not fit entirely through; only the bulb itself will pass through. The light bulb may be secured in place by forming a latch to hook onto molded hooks on the backside of the reflector and pass over the base of the bulb to press the base against the slot of the reflector. The latch then performs as a spring base latch so that in order to remove the bulb, the latch may be released from the hooks.

Unfortunately, however, a problem with this mounting technique is that molded hooks are required on the back side of the reflector to hold the latch. And using current molding techniques, when the hook features are made, holes are created in the reflector, which may be seen from the front side of the reflector (the “class A” side). The hooks are formed to the shape of mold protruding through this hole. The visible mark on the class A side of the reflector is aesthetically displeasing for external view.

In addition, the holes in the reflector, created by forming the hooks, can result in a certain size and leave a void in the reflector, which may distort reflected light rays. Also, the holes need to be sealed in some manner to protect the internal light device. This is typically accomplished via a rubber boot positioned over the backside of the reflector, and some type of ventilation would have to be formed within the rubber boot to allow air to pass through the light device.

### SUMMARY

In accordance with an exemplary embodiment, a light source housing is provided. The light source housing comprises a reflector with a front and a back. The reflector also has an opening defined through the reflector and a mounting block on the back of the reflector. The light source housing further comprises a bulb shield that has a mounting arm with a curved end. The mounting arm is positioned through the opening so that the curved end hooks over the mounting block and provides a light source securing latch.

In another embodiment, a light device is provided. The light device comprises a housing that has an opening defined through a side of the housing. The light device also has a light source positioned within the opening, and a bulb member that has a mounting arm with a curved end. The mounting arm is positioned through the opening so that the curved end provides a latch area to secure the light source in place.

In still another embodiment, a method of mounting a light source in a light device is provided. The method includes providing a housing that has a light source receiving slot and providing a bulb member that has a mounting arm with a curved end. The method also includes positioning the light source in the light source receiving slot. The method further includes, using a fastener, securing the light source in the light source receiving slot by hooking the fastener under a latch provided by the curved end.

These as well as other features and advantages will become apparent to those of ordinary skill in the art by reading the following detailed description, with appropriate reference to the accompanying drawings.

### BRIEF DESCRIPTION OF FIGURES

Reference is made to the attached figures, wherein like reference numerals refer to like elements, and wherein:

FIG. 1 is a perspective view of a light source housing according to one embodiment;

FIG. 2 is a side view of the light source housing in FIG. 1;

FIG. 3 is a plan view of a light device according to one embodiment;

FIG. 4 is another plan view of the light device of FIG. 3;

FIG. 5 is a rear view of the light device of FIG. 3;

FIG. 6 is a side view of a portion of the light device illustrated along cross-section A of FIG. 5;

FIG. 7 is another side view of a portion of the light device; and

FIG. 8 is another rear view of the light device.

### DETAILED DESCRIPTION OF EXEMPLARY EMBODIMENTS

According to an exemplary embodiment, a light source securing mechanism is provided within a light source housing and a light device. As one example, the light source securing mechanism comprises a bulb shield leg and a molded portion of a reflector of the light housing. The bulb shield leg may be folded over the molded portion of the reflector to create a hook for a retention member to latch underneath. The retention member may be positioned to secure a light source within the light device.

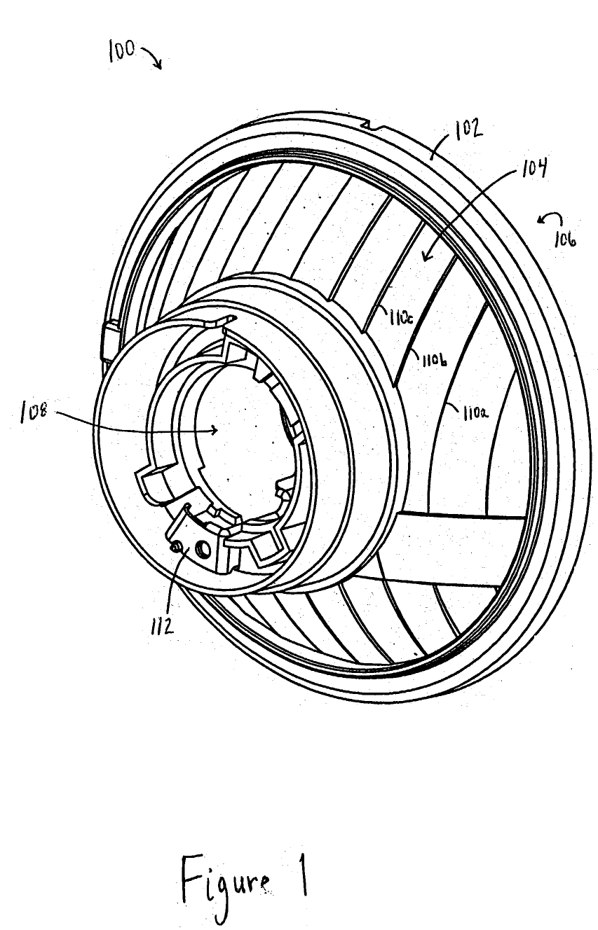

Referring now to the figures, and more particularly to FIG. 1, a perspective view of one embodiment of a light source housing 100 is illustrated. It should be understood that the light source housing 100 illustrated in FIG. 1 and other arrangements described herein are set forth for purposes of example only, and other arrangements and elements can be used instead and some elements may be omitted altogether, depending on manufacturing, design, and/or consumer preferences.

By way of example, the light source housing 100 includes a reflector 102 with a backside 104 and a frontside 106 and an opening 108. The light source housing 100 also includes a bulb shield (not shown).

The reflector 102 is illustrated as circular, however, the reflector 102 may take any form for any desired application. The reflector 102 is shown to include many facets, such as facets 110a-c, which are stepwise elements in the surface of the frontside 106 of the reflector 102. The reflector 102 may comprise a plastic material with a reflective coating or finish on the frontside 106.

The opening 108 functions as a light source receiving slot in which a light source may be positioned. Therefore, the opening 108 can be designed according to a size and shape of the desired light source.

In addition, the bulb shield (not shown) may be positioned within the light source housing 100 to cover the light source. The bulb shield has a mounting arm (not shown) with a curved end 112, which is positioned through the opening 108, and is used to secure the bulb shield in place within the housing. Also, the curved end 112 provides a light source securing means (described more fully below).

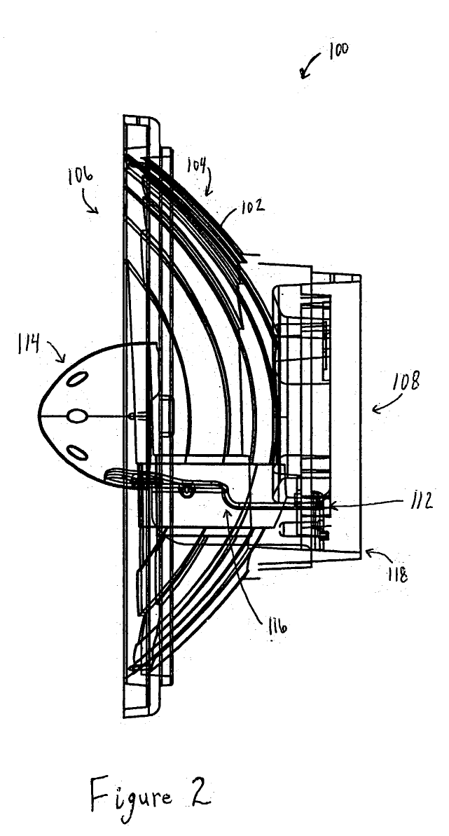

FIG. 2 is a side view of the light source housing 100. The light source housing 100 is shown with a bulb shield 114 positioned in the light source housing 100. The bulb shield 114 has a mounting arm 116 with the curved end 112. The bulb shield 114 is positioned to cover a middle portion of the light source housing 100 or simply to cover a light source that is mounted in the light source housing 100. The bulb shield 114 may be mounted in various configurations using the mounting arm 116. For example, in FIG. 2, the curved end 112 of the mounting arm 116 is positioned through the opening 108 such that the mounting arm 116 is located at a bottom 118 of the light source housing 100. The bulb shield 114 may aid in steering light radiated from a light source in a desired direction. Light may be collected in the bulb shield 114 and re-distributed outward to all sides of the bulb shield 114. The bulb shield 114 may comprise a temperature resistant material such as a nickel-chromium alloy.

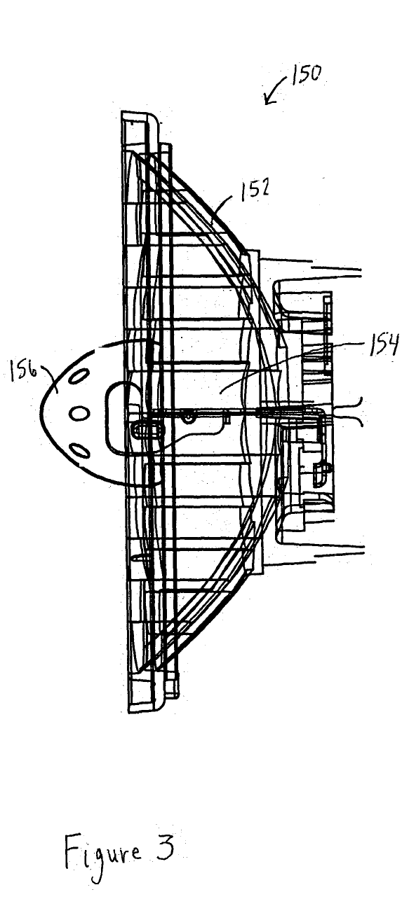

FIG. 3 is a plan view of a light device 150 according to one embodiment. The light device 150 includes a reflector 152, a light source 154, and a bulb shield 156. The light source 154 may comprise various types of light bulbs. For example, the light source 154 may be an HB2 12V 55-60 W light bulb. The bulb shield 156 is positioned to cover the light source 154 and steer light rays emitted from the light source 154.

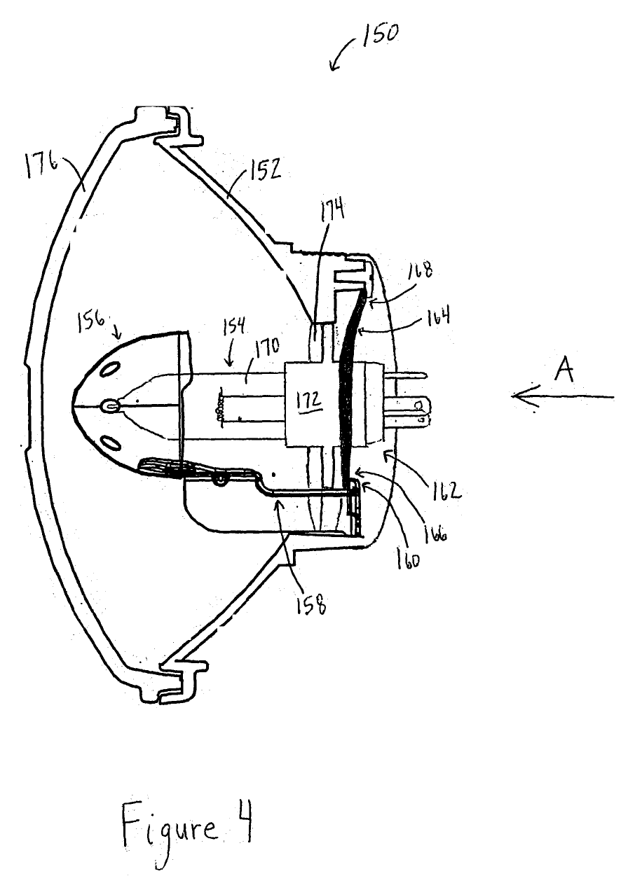

FIG. 4 is another plan view of the light device 150. Here, the bulb shield 156 is shown to include a mounting arm 158 with a curved end 160. The mounting arm 158 is positioned through an opening 162 of the reflector 152 and the curved end 160 is secured to the reflector 152 (possibly by simply screwing the curved end 160 to the reflector 152). The curved end 160 provides a light source securing means. For example, the curved end 160 is positioned over a mounting block (not shown) on the reflector 152 such that a portion of the curved end 160 extends beyond the mounting block providing an area for a retaining spring latch 166 to lock the light source 154 in place. An opposite end 168 of a retaining spring 164 is secured to the reflector 152.

The light source 154 has a light bulb 170 and a base 172. The opening 162 of the reflector 152 is large enough such that the light bulb 170 may fit through the opening 162 when inserted as shown by arrow A. The reflector 152 has a light source seat 174, which the base 172 of the light source 154 abuts. The retaining spring 164 is positioned to press the base 172 of the light source 154 against the light source seat 174 securing the light source 154 within the reflector 152.

FIG. 4 illustrates the light device 150 with a lens 176. The lens 176 couples to the reflector 152. The lens 176 provides additional light reflective means to direct light rays in a desired direction. The lens 176 may comprise a number of optical elements, such as Fresnel optics, step-wise facets, and others. The lens 176 may comprise a material through which light rays may travel, such as glass or plastic, and may comprise any color according to a desired application.

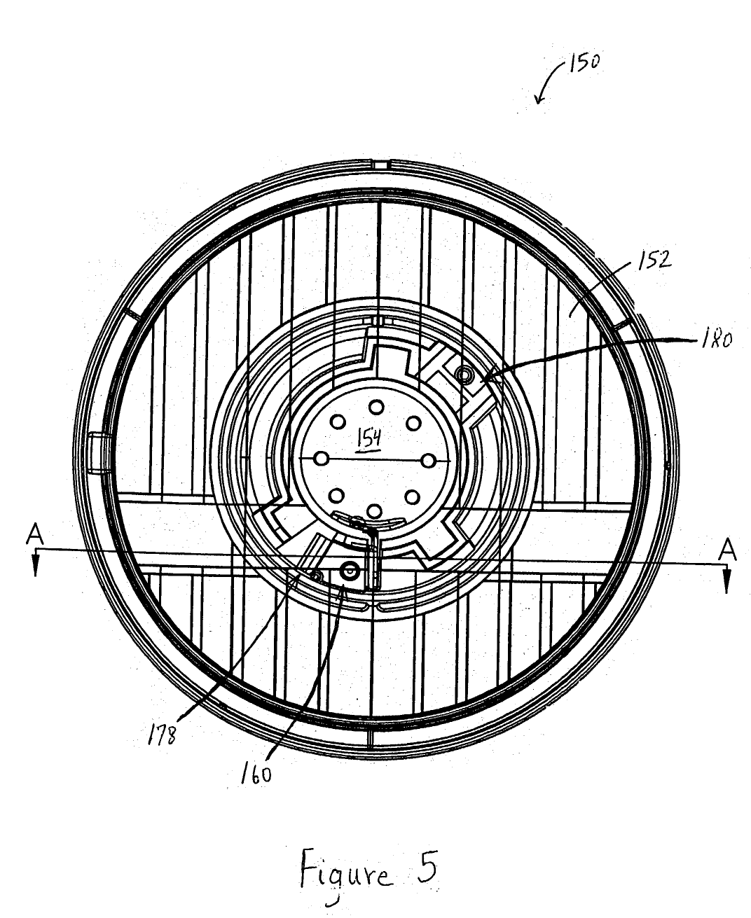

FIG. 5 is a rear view of the light device 150. FIG. 5 illustrates the light source 154 positioned in the reflector 152. Also, the curved end 160 is positioned over a mounting block (not shown) such that an area 178 is present for the retaining spring (not shown) to latch. And the opposite end of the retaining spring may be secured under a latch 180 which can be formed within the reflector, or may simply be a screw to secure the opposite end of the retaining spring against the backside of the reflector 152.

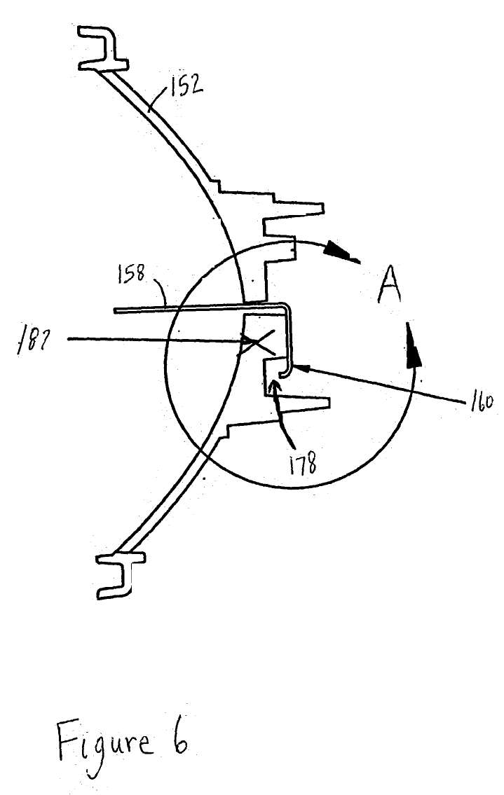

FIG. 6 is a side view of a portion of the light device 150 illustrated along cross-section A of FIG. 5. The mounting arm 158 is positioned through the reflector 152 and the curved end 160 is positioned over a mounting block 182 that is present on the backside of the reflector 152. The mounting block 182 and the curved end 160 of the mounting arm 158 are designed such that after assembly, the area 178 is present underneath the extending portion of the curved end 160 for the retaining spring (not shown) to latch.

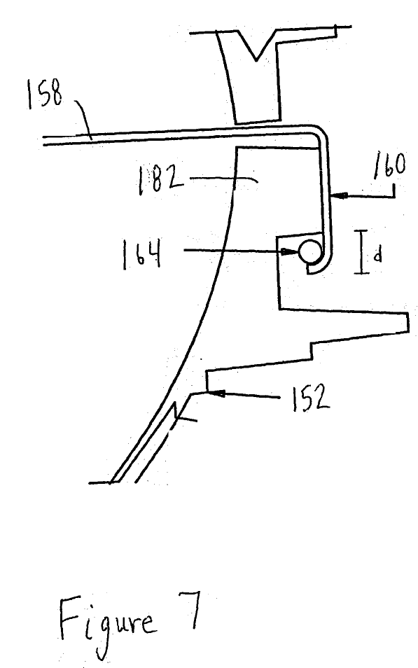

FIG. 7 is another side view of a portion of the light device 150. FIG. 7 illustrates an end of the retaining spring 164 positioned under the curved end 160 of the mounting arm 158. The retaining spring 164 then is held in place by the curved end 160 and the mounting block 182. Also, the curved end 160 is positioned over the mounting block 182 such that a portion of the curved end 160 extends beyond the mounting block 182, shown by distance d, providing an area for the retaining spring 164 to lock.

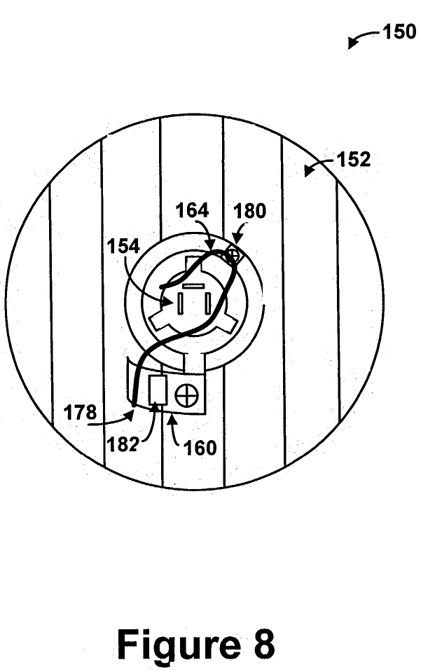

FIG. 8 is another rear view of the light device 150. The retaining spring 164 is illustrated with one end secured underneath the curved end 160 in the area 178 next to the mounting block 182 and the other end secured to the area 180 of the reflector 152. The retaining spring 164 extends over the backside of the light source 154 and applies a force against the backside of the light source 154 to secure the light source 154 in place.

The retaining spring 154 may be a type of fastener, not limited to a spring mechanism. The retaining spring 154 may be compressed to disengage the end from underneath the latch area 178 to remove the light source 154 from the light device 150.

In one embodiment, the curved end 160 of the mounting arm 158 of the bulb shield 156 provides a latching means for the retaining spring 164 to hook underneath. The latching means may be created by molding the mounting block 182 of the latch feature into the reflector 152 in die draw and folding the end of the mounting arm 158 over the mounting block 182 to create the curved end 160. This provides a low profile, inexpensive technique of securing the light source 154 within the light device 150 using a fastener to hook under the curved end 160. No additional hooks are required on the reflector. Rather, the mounting block 182 may simply be molded within the backside of the reflector.

In addition, no stamping is required, as when forming hooks, therefore there are no visible marks on the class A side of the reflector 152 and no voids in the reflector 152. Eliminating the voids also eliminates the need for a sealing boot positioned around the backside of the reflector 152.

The curved end 160 and the mounting block 182 provide a light source securing means with an aesthetically pleasing external view. And by molding the mounting block 182 in die draw, the latching means is created in a cost effective manner.

In one embodiment, the light source housing 100 and the light device 150 may be used within vehicle lighting devices, such as an automobile or motorcycle headlight. Other examples include other automotive light devices, such as a taillamp, a stop lamp, a license plate lamp, a rear end and front end side marker lamp, a headlamp, a fog lamp, an exterior courtesy lamp, or a turn signal lamp, each of which may be mounted at a respective position on an automotive vehicle. Although, those skilled in the art will understand that the light source housing 100 and the light device 150 may be any vehicle light device that has any desired configuration and/or stylistic properties.

While the present invention has been described in co junction with presently preferred embodiments of the invention, persons of skill in the art will appreciate that variations may be made without departure from the scope and spirit of the invention. This true scope and spirit is defined by the appended claims, which may be interpreted in light of the foregoing.

We claim:

1. A light source housing comprising:
a reflector having a front and a back, the reflector having an opening defined through the reflector, and a mounting block on the back of the reflector; and
a bulb shield having a mounting arm with a curved end, the mounting arm positioned through the opening so that the curved end hooks over the mounting block and provides a light source securing latch.

2. The light source housing of claim 1, wherein a portion of the curved end extends over the mounting block and provides an area for a latch to fasten.

3. The light source housing of claim 1, wherein the light source housing is a vehicle headlight housing.

4. The light source housing of claim 1, further comprising a retaining spring having one end secured to the back of the reflector and another end operable to fasten under the light source securing latch.

5. A light device comprising:
a housing having an opening defined through a side of the housing;
a light source positioned within the opening; and
a bulb member having a mounting arm with a curved end, the mounting arm positioned through the opening so that the curved end provides a latch area to secure the light source in place.

6. The light device of claim 5, wherein the light device is an automotive vehicle light device.

7. The light device of claim 5, wherein the light source is a light bulb.

8. The light device of claim 5, wherein the bulb member is a bulb shield.

9. The light device of claim 5, wherein the bulb member is positioned to cover the light source.

10. The light device of claim 5, wherein the housing has a mounting block.

11. The light device of claim 10, wherein the curved end slides over the mounting block such that a portion of the curved end extends beyond the mounting block thereby providing the latch area.

12. The light device of claim 5, wherein the light source has a light bulb and a base and wherein the light source is positioned through the opening such that the base abuts the opening.

13. The light device of claim 12, further comprising a retaining spring having one end secured to the housing and one end secured in the latch area, Wherein the retaining spring is positioned to press the base of the light source against the housing to hold the light source in place.

14. The light device of claim 5, further comprising a lens coupled to the housing.

15. A method of mounting a light source in a light device, the method comprising:
providing a housing having a light source receiving slot;
providing a bulb member having a mounting arm with a curved end;
positioning the light source in the light source receiving slot; and
using a fastener, securing the light source in the light source receiving slot by hooking the fastener under a latch provided by the curved end.

16. The method of claim 15, wherein the fastener is a retaining spring.

17. The method of claim 15, further comprising sliding the curved end over a mounting block of the housing such that a portion of the curved end extends beyond the mounting block to provide the latch.

18. The method of claim 15, wherein securing the light source in the light source receiving slot comprises positioning a retaining spring to press against a base of the source.
